(19) United States
(12) Patent Application Publication
(10) Pub. No.: US 2015/0098066 A1
(43) Pub. Date: Apr. 9, 2015

(54) INTERFEROMETRIC SPATIAL LIGHT MODULATOR FOR PRODUCTION OF DIGITAL HOLOGRAMS

(71) Applicant: Bayer MaterialScience LLC, Pittsburgh, PA (US)

(72) Inventor: David Jurbergs, Austin, TX (US)

(21) Appl. No.: 14/368,828

(22) PCT Filed: Dec. 21, 2012
(86) PCT No.: PCT/US2012/071156

§ 371 Date: Jun. 26, 2014

Related U.S. Application Data
(60) Provisional application No. 61/581,726, filed on Dec. 30, 2011.

(51) Int. Cl. G03H 1/08; G03H 1/04; G03H 1/00

(52) U.S. Cl. CPC G03H 1/0891; G03H 1/0011; G03H 1/0443
USPC 355/2

(57) ABSTRACT

A digital holographic apparatus, system, and method are disclosed. The apparatus includes an electronic display device comprising an interferometric spatial light modulator based display engine and a processor coupled to the electronic display device. The processor is operative to upload digital content to the electronic display device. The digital content is displayed on the electronic display device and is recorded into a holographic medium when the holographic medium and the electronic display device are flood exposed by a laser generated light beam. The system additionally includes at least one laser coupled optically coupled to the electronic display device and communicatively coupled to the processor. A method of recording a digital hologram in a holographic medium using the digital holographic system also is disclosed.

### BACKGROUND OF THE INVENTION

In one aspect, the present disclosure relates generally to electronic display devices comprising interferometric spatial light modulators for digitally producing holograms. More specifically, the present disclosure relates to digital holographic systems comprising an electronic display device comprising interferometric spatial light modulators for producing digital holograms including two-dimensional and three-dimensional color holograms.

Although holography plays a critical role in a wide variety of security and authentication applications, it suffers from several limitations. First, because nearly all security holograms are produced by embossing processes from expensive masters, individualization of the holograms, themselves, is not commercially viable. Other facets of a document, label, among others, may be individualized and/or personalized, like personal information and photographs on an identification (ID) card or laser engraved serial numbers on a label, but such holograms employ a repeated design. This reduces security because successful removal and reapplication of the one design to other documents or recreation of the one design enables a counterfeiter to bypass the security. If a unique hologram could be produced with individual information, then transfer would be no good and the barrier to recreate individual designs would be too high.

Second, embossed or surface-relief holograms have poor color quality (i.e. they often look rainbow colored due to the properties of being transmission holograms). In addition to the aesthetic reasons for full color imagery, full color holograms can be important for branding and in deterring counterfeits (because many times the proper coloration is known to end users).

Third, embossed or surface-relief holograms require light to be reflected through them. This is often done with an opaque metallized layer placed beneath the hologram. Such layers give holograms their shiny appearance and prohibit design integration with traditional printed graphics. For improved security, aesthetics, and/or integration reasons, it is often desired that the holographic security feature be partially or fully transparent. The former can be achieved with selective demetallization; however, such processes are difficult, expensive, and still leave partially opaque designs. The latter can be achieved with high-refractive index materials, but such materials are more costly and the holographic features are often less visible due to weaker reflectivity.

Fourth, the process of making an embossed hologram requires first producing a master which can be made in a number of processes, but all are slow, time consuming, difficult, and expensive. For example, once an embossing master is made it must be transferred to an embossing cylindrical shim by way of a photolithographic process. After the cylindrical shim is created, it is placed on a roller in a web-based manufacturing line to produce—emboss—the same hologram design in a repeated fashion. Changing the holographic design requires changing the master, producing a new shim, and replacing the roller on the web-based machine.

The ability to record individualized or personalized information into a volume holographic medium is well known. Several companies and independent researchers that work on stereograms or digital holography have shown the ability to record individual information on volume holographic media. Although there are many approaches that can be taken to record individual information into a hologram, for individualization processes to be commercially viable in today's world there is a need to utilize digital information technology.

For example, it would be desirable to make a photo ID in which the “photo” was recorded as a hologram, where a photo captured by a digital camera can be transferred by a computer to a hologram printer. Although such holographic printing has been described and demonstrated numerous times, it should be noted, however, that such holographic printing is very different from conventional printing. Nevertheless, throughout the present disclosure, the term “holographic printer printing” will be used to convey the concept of a machine used to record a hologram from digitally conveyed information.

### SUMMARY OF THE INVENTION

In one embodiment, a digital holographic apparatus is provided. The apparatus comprises an electronic display device comprising an interferometric spatial light modulator based display engine and a processor coupled to the electronic display device. The processor is operative to upload digital content to the electronic display device. The digital content is displayed on the electronic display device and is recorded into a holographic medium when the holographic medium and the electronic display device are flood exposed by a laser generated light beam.

### BRIEF DESCRIPTION OF THE FIGURES

The present invention will now be described for purposes of illustration and not limitation in conjunction with the figures, wherein:

FIG. 1 is a diagram of one embodiment of a two-dimensional (2D) digital holographic system employing an interferometric spatial light modulator based display engine;

FIG. 2 is a simplified diagram of an optical system comprising an interferometric spatial light modulator based display engine for use in the digital holographic system shown in FIG. 1;

FIG. 3 is a diagram of one embodiment of a two-dimensional (2D) digital holographic system employing an interferometric spatial light modulator based display engine;

FIG. 4A is an illustration of a sub-pixel element of an interferometric spatial light modulator based display in an open state;

FIG. 4B is an illustration of the sub-pixel element of FIG. 4A shown in a collapsed state;

FIG. 4C is an illustration of a pixel element of an interferometric spatial light modulator based display;

FIG. 5 is a diagram illustrating the trade-off between the brightness and viewing window of a holographic image;

FIG. 6 is a diagram of one embodiment of a three-dimensional (3D) digital holographic system for recording high-density full-color full-parallax holographic stereograms employing an interferometric spatial light modulator based display engine;

FIGS. 7A-C illustrates a commercially available device having a display comprising an interferometric spatial light modulator based display engine;

FIG. 8 illustrates a computer system which may be employed to control a digital holographic process in accordance with the present disclosure;

FIGS. 9A and 9B provide a schematic showing the difference between the holographic recording of a mirror-like element, such as an IMOD, with (FIG. 9B) and without (FIG. 9A) the use of an angularly shifting optic, such as a wedge prism;

FIG. 10A is a photograph of sample D0110211L;

FIG. 10B is a photograph of sample D0110211Q;

FIG. 10C is a photograph of sample D0110211U;

FIG. 11 is a photograph of sample D110214D using a point-like light source (tungsten halogen lamp);

FIGS. 12A and 12B provide a schematic of the two orientations used for recording with the wedge prism;

FIGS. 13A and 13B are photographs of sample D110214M using a point-like light source (tungsten halogen lamp) in FIG. 13A and using a diffuse light source (a ground-glass diffuser with same lamp) in FIG. 13B; and

FIG. 14 is a photograph of sample D110214N using a point-like light source (tungsten halogen lamp) and a ground-glass diffuser placed in the light beam such that about half of the sample (right-side) is illuminated with light passing through the diffuser and half (left-side) is not.

### DETAILED DESCRIPTION OF THE INVENTION

The present disclosure provides various embodiments of digital holographic systems and methods and techniques for controlling such digital holographic systems. In various aspects, the present disclosure provides various apparatus, systems, and methods for optically recording a digitally generated image using digital content, which may comprise text, graphics, images, and combinations thereof, onto a volume holographic medium. The apparatus, systems, and methods according to the disclosed embodiments can be integrated in web-based manufacturing processes to produce unique, customized, and individualized holograms by displaying digital content on a display device comprising an interferometric spatial light modulator display engine, as will be described in detail hereinbelow. As used throughout the present disclosure, a display device is an electronic output device for presentation of information in a visual form where the input information is supplied as an electrical signal and may be referred to as electronic display device.

The present invention provides a digital holographic apparatus, comprising an electronic display device comprising an interferometric spatial light modulator based display engine and a processor coupled to the electronic display device, wherein the processor is operative to upload digital content to the electronic display device, wherein the digital content is displayed on the electronic display device and is recorded into a holographic medium when the holographic medium and the electronic display device are flood exposed by a laser generated light beam.

The present invention further provides a method of recording a digital hologram in a holographic medium using a digital holographic system, the method involving displaying digital content on a an electronic display device, the electronic display device comprising an interferometric spatial light modulator based display engine, providing a holographic medium between a laser light source and the digital content displayed on the electronic display device, and generating at least one laser beam by at least one laser to flood expose the holographic medium and the electronic display device to record the digital content into the holographic medium.

The present invention also provides a digital holographic system comprising an electronic display device comprising an interferometric spatial light modulator based display engine, at least one laser optically coupled to the electronic display device, the at least laser operative to generate at least one light beam at first wavelength, a processor coupled to the electronic display device and to the at least one laser, wherein the processor is operative to upload digital content to the electronic display device, and wherein the digital content is displayed on the electronic display device and is recorded into a holographic medium when the holographic medium and the electronic display device are flood exposed by the at one laser generated light beam.

For example, in a production process, digital content in the form of text, graphics, and/or a digitized image of an individual's face, or other recognizable characteristic, feature, or insignia, is uploaded to and displayed on an electronic display device comprising an interferometric spatial light modulator display engine. The displayed content is then recorded in a volume holographic medium. Once the digital content is optically recorded in the hologram, the process may be repeated to record another individual's face, or other recognizable characteristic or feature, onto a different portion of the volume holographic medium. Accordingly, customized, individualized, and/or unique holograms can be generated on the fly quickly and efficiently in a computerized process by changing the digital content being displayed and automatically positioning an unexposed portion of volume holographic medium to record the hologram thereon. The process enables the quick and efficient production of customized, individualized, and/or unique holograms that also may include custom security features, component serial numbers, and the like. The process may be employed to record such customized, individualized, and/or unique information onto holograms in passports, driver's licenses, identification cards, official documents, and so on.

In one embodiment, the digital holographic system in accordance with the present disclosure comprises an electronic display device for displaying digital content. In one embodiment, the electronic display device comprises an interferometric spatial light modulator display (IMOD) spatial light modulator (SLM) module, which may be employed to create a digital hologram by a holographic printer, which may be referred to herein as a digital holographic system. In conventional holographic printers, the pattern to be recorded in holographic medium is displayed on one or more SLMs—usually either liquid crystal displays (LCD) or digital micro-mirror devices (DMD). Full color red-green-blue (RGB) holography typically requires three separate DMDs, one for each color, which adds significant complexity. Single LCDs can be used for full-color holographic printing, but LCDs add polarization challenges.

In various embodiments, the present disclosure provides a digital holographic system comprising an electronic display device that comprises an IMOD based display engine for producing an improved digital holographic system. Those skilled in the art will appreciate that “IMOD” is a term used by Qualcomm to refer to its “interference modulator” technology based on optical micro-electro-mechanical systems (MEMS). One example of an IMOD module is a digital display known under the trade name MIRASOL available from Qualcomm MEMS Technologies of San Diego, Calif. One advantage of using IMOD technology for the digital holographic systems described herein include, for example, the capability of producing full-color images on a single electronic display device by using color sub-pixels, which greatly simplifies the design and operation of a holographic printer. In addition, the optics implementation of a holographic printer based on IMOD display devices is much simpler as IMOD elements are based on interference effects and not on polarization changes. Finally. IMOD elements are highly reflecting, making them well suited for forming high contrast fringes in a volume holographic medium, creating “mirror-like” or specular security holograms with high brightness to be easily produced, and efficiently using laser light.

The optical properties of the light output from an IMOD element are considerably different from those of most liquid crystal based SLMs. Accordingly, IMOD based holographic printer engines are simpler to make and the resulting holograms have considerably different appearance and are well suited for security and authentication applications, for example. In various implementations, the IMOD based SLM can be used for printing two-dimensional or three-dimensional holographic images, depending on the configuration of the printer and associated electronics.

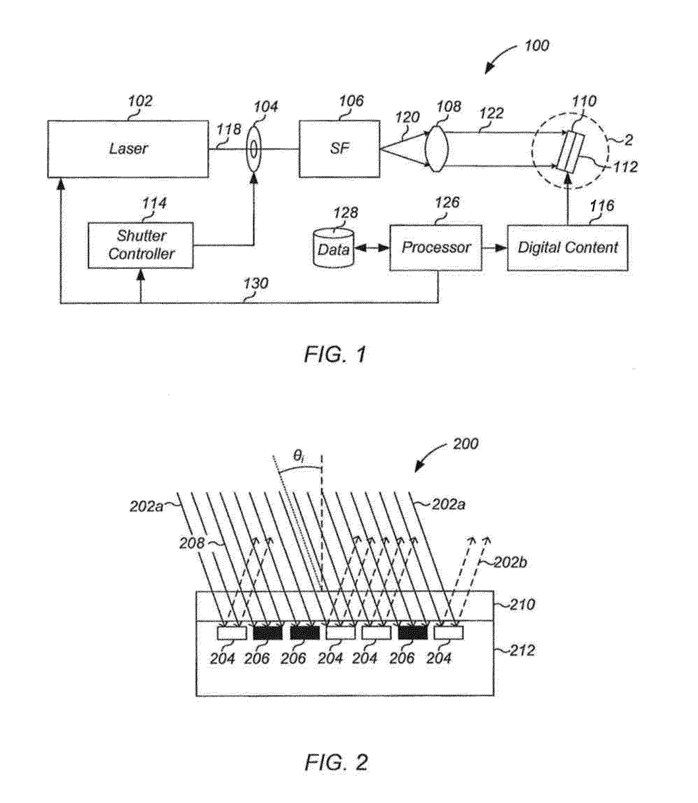

Turning now to FIG. 1, a diagram of one embodiment of a two-dimensional (2D) digital holographic system 100 is described. In the embodiment illustrated in FIG. 1, the 2D digital holographic system 100 comprises an electronic display device 112, which comprises an interferometric spatial light modulator based display engine. The system 100 further comprises a laser 102 and a shutter system comprising a shutter 104 and a shutter controller 114 communicatively coupled to the shutter 104. The shutter 104 optically couples the laser beam 118 to a spatial filter 106, which is optically coupled to an image processing site 2 by way of one or more optical elements 108. A computer system comprising a processor 126 is coupled to the image processing site 2, the laser 102 and/or shutter controller 114, and a storage device 128 which stores digital content to be recorded in a holographic medium. The storage device 128 may include a database of digital content 116. The image processing site comprises fixtures or plates to position a holographic medium 110 in optical relationship with the electronic display device 112. Digital content 116 can be stored in the storage device 128 using any suitable means including manually uploading the digital content, remotely uploading the digital content, among other techniques. For example, the digital content 116 may be obtained from a remote computer over wide area networks such as the Internet.

In operation, the laser generates a beam 118 which is transmitted to a shutter 104 to control exposure of the holographic medium 110. The shutter 104 is controlled by a shutter controller 114. When the shutter 104 is open, the beam 118 is transmitted to a spatial filter 106. In one embodiment, the spatial filter 106 may be comprised of a combination of an objective lens and a pinhole, for example. From the spatial filter 106, a broadened beam 120 is transmitted through an optical element such as a lens 108 to produce a collimated beam 122. The lens 108 may be a collimating lens or a near collimating lens. The collimated beam 122 is transmitted to the holographic medium 110 to record the displayed digital content therein. The holographic medium 110 may be positioned in direct contact with or in spaced apart relation from the output surface of the electronic display device 112. In accordance with the disclosed embodiments, the electronic display device 112 comprises an interferometric spatial light modulator based display engine, which is described hereinbelow in connection with FIG. 2.

Still referring to FIG. 1, the processor 126 is operative to retrieve digital content 116 from the storage device 128 and provide (e.g., upload, transmit, input) the digital content 116 to the electronic display device 112, where the holographic information is to be displayed for recording into the holographic medium. The digital content 116 displayed by the electronic display device 112 may be recorded into the holographic medium 110 using a variety of techniques such as flood exposure by the light generated by the laser 102. In one embodiment, a feedback loop 130 communicatively couples the processor 126 to the laser 102 and/or the shutter controller 114, wherein the processor 126 is operative to control the ON/OFF state of the laser 102 and/or shutter controller 114. For example, upon uploading the digital content 116 to the electronic display device 112, the processor 126 is operative to activate the laser 102 and/or the shutter controller 114 to expose the hologram. The processor 126 also may control the positioning of the holographic media 110 for recording the digital content 116 thereon.

Accordingly, in one embodiment, the processor 126 may be operative to retrieve the digital content 116 from the storage 128 and upload the digital content 116 to the electronic display device 112 where it is displayed. The processor 126 then is operative to signal to position an unexposed section of holographic media 110 over the electronic display device 112, activate the laser 102 and/or the shutter controller 114, and record the digital content 116 displayed on the display 112 into the holographic medium 110. Once the hologram is recorded in the exposed portion of the holographic medium 110, the processor 126 deactivates the laser 102 and/or the shutter controller 114, positions an unexposed portion of the holographic medium 110, and uploads new digital content 116 to the electronic display device 112, and so on. It will be appreciated that in certain embodiments more than one hologram may include the same digital content whereas in other embodiments each hologram will contain unique digital content.

As used throughout the present disclosure the digital content 116 refers to any digital information to be recorded in a holographic medium to produce a hologram. For example, digital content may comprise text, graphics, images, and any combinations thereof, among other information to be recorded in a hologram and also may be referred to herein as holographic information. Text may comprise, for example, both numeric and alphanumeric information used for identification purposes, such as, for example, serial numbers. Graphics may comprise, for example, graphical information including logos, corporate identification graphics, government agency identification graphics and official seals, and the like. Images may comprise, for example, digitally captured photographs which can be stored in memory in digital form and include both digitally captured images as well as digitally scanned images stored in digital form.

In one embodiment, the holographic medium 110 may be a volume photopolymer holographic material such as, for example, BAYFOL HX film available from Bayer MaterialScience AG of Germany (or Bayer MaterialScience LLC of Pittsburgh, Pa.). Volume holographic materials like BAYFOLI HX film enable the optical recording of reflection holograms, which cannot be produced by embossing processes. Such holograms enable full color imaging to be done and do not utilize a separate reflector. Many of the BAYFOL HX experimental formulations have very high transparency, which enables the possibility of integration between holographic design features and printed design features. In other embodiments, any suitable holographic medium or film may be employed without limitation. For example, silver halide photopolymer film or Dichromated Gelatine (“DCG”) media for holographic applications may be employed in the digital holographic system 100 without limitation.

In one embodiment, the electronic display device 112 comprising the interferometric spatial light modulator based display engine may be, for example, a flat panel digital display available from Qualcomm MEMS Technologies of San Diego, Calif. and known under the trade name iMoD (IMOD). The electronic display device 112 receives digital content 116 (e.g., holographic information such as text, graphics, images) from devices such as the processor 126 and displays the information by controlling the state of the output pixels. The interferometric spatial light modulator based display engine includes a plurality of pixels comprising one or more sub-pixels. A controller controls the state of each pixel such that when a sub-pixel is turned ON (the sub-pixel is in an open state) light rays incident on the surface of the sub-pixel are reflected back into the holographic medium 110. When a sub-pixel is turned OFF (the sub-pixel is in a collapsed state) incident light rays are absorbed by the sub-pixel and thus are not reflected back into the holographic medium 110. The elements and operation of the interferometric spatial light modulator based display engine according to the present disclosure are described in more detail herein below with respect to FIGS. 2, 3, and 4A-4C.

In a web-based production line process, for example, the holographic medium 110 can be provided in the form of a roll where unexposed portions can be positioned over the electronic display device 112. When the electronic display device 112 displays the digital content 116 retrieved from the storage device 128, the holographic medium 110 is positioned between the collimated beam 122 and the holographic medium 110 and is held in place until the digital content 116 displayed on the electronic display device 112 is recorded into the holographic medium 110. The recording process is conducted by controlling the operation of the laser 102 and/or the shutter 104 by the processor 126 to allow the collimated laser beam 122 to flood expose the holographic medium 110. Once the hologram is recorded, either the same or different digital content 116 is displayed on the electronic display device 112, an unexposed section of the holographic photopolymer 110 is positioned in front of the electronic display device 112, and the displayed digital content 116 is recorded into the holographic medium 110 by way of flood laser exposure. The process may be repeated as desired.

In one embodiment, the shutter system comprised of the shutter 104 and the shutter controller 114. In one embodiment, the shutter 104 may be selected from any one of a series of electro-programmable optical shutter systems that are especially well suited for laser use, with applications including low level chopping, pulse gating, selection, and modulation to 400 Hz. Such electronic shutters are known under the trade name UNIBLITZ LS available from Vincent Associates of Rochester, N.Y. Such electro-programmable shutter systems have precise repeatable characteristics and particularly well suited for precision exposure control in holography applications. The UNIBLITZ LS shutter series is available in three configurations. The LS2 model features a 2 mm aperture and a typical rise time of 300 μsec. The LS3 and LS6 models feature a 3 mm and 6 mm aperture, respectively. All three models may be configured for mounting in a black anodized aluminum housing and may be equipped with an electronic synchronization system. In addition, the shutters may include microscope and video mounts. The LS laser shutter systems are rated for laser energy up to 5 W/mm² with “Z” or “ZM” shutter blade coating options. The LS laser shutter systems can be operated at an exposure repetition rates from DC—400 Hz and may be equipped with an electronic synchronization system.

In one embodiment, the shutter controller 114 may be a VMM-T1 single channel shutter driver/timer, also available from Vincent Associates of Rochester, N.Y. This particular shutter controller provides a complete timer/driver system for normally open or closed operation of the shutter 104. The shutter controller 114 may incorporate features suitable for holography control applications to provide precision control, flexibility, accuracy, and repeatability. In one embodiment, the VMM-T1 shutter controller provides an exposure and delay interval range from 0.1 ms to 2.8 hours. The VMM-T1 shutter controller also provides three choices for both internal timer activating and resetting. In addition, the shutter 104 can be controlled from the BNC inputs, these inputs can also be controlled via a computer serial port (RS-232C). By selecting the proper address for each unit, up to eight (8) devices can be controlled from one serial port.

In one embodiment, the spatial filter 106 may comprise a 910A compact five axis spatial filter available from Newport Corporation of Irvine, Calif. The 910A spatial filter combines five-axis alignment with high stability for set-and-forget adjustment. The 910A spatial filter also provides precise XY translation of the pinhole plus true gimbaling of the entire assembly using precision 100 threads-per-inch (TPI) screws with knobs that include an integral hex hole, providing smooth, high-resolution motion. In one aspect, the 910A spatial filter provides a zero-freeplay XY mechanism to ensure accurate positioning and enhanced long-term stability. Translation along the optical Z-axis may be accomplished without rotation of the pinhole by a knurled ring with a precision 80 TPI thread. Mounted pinholes may be threaded into the body of the 910A spatial filter. RMS-threaded objective lenses may be attached to the lens holder, which may be clamped to the positioner. The lens holder also has an integral iris so diaphragm to aid in coarse alignment of the beam to the spatial filter 106 and for blocking out stray light. Objective lenses may be added. The 910A spatial filter accommodates M-, MV-, and L-Series Objective Lenses, and 910PH-Series Mounted Pinholes. For maximum stability when mounting directly to an optical table, the spatial filter 106 may be supplied with a slotted base plate that can be attached to either side of the unit. The spatial filter 106 can also be post mounted, using either the 8-32 or M4 threaded hole in the bottom.

In one embodiment, the spatial filter 106 also may comprise a microscope objective lens. For example, the spatial filter 106 may comprise a M-20× microscope objective that has a 20× magnification, 0.40 numerical aperture, 9.0 mm focal length, and 6.0 mm clear aperture also available from Newport Corporation of Irvine, Calif. The objective may be corrected for a rear conjugate at 160 mm. The lenses may comprise an antireflection coating such as MgF₂ for the visible spectrum. The M-20× objective is suitable for use with either the Model 900 or 910A spatial filters. The M-series microscope objective power is based on a 160 mm tube length, MP=160 mm/f.

In one embodiment, the spatial filter 106 also may comprise a high energy pinhole aperture. For example, the spatial filter 106 may comprise a high energy pinhole aperture model number 910PH-10 fabricated from ultra-thin molybdenum, which is a refractory alloy with high heat conductivity and melting point, also available from Newport Corporation of Irvine, Calif. The material exhibits almost no warping due to localized heating by the laser. The pinhole is a smooth 10±1 μm diameter hole with extremely low ellipticity and may be produced using laser drilling techniques. Such pinholes have a laser damage threshold of 75 MW/cm² CW and are suitable for pulsed laser use up to 700 mJ/cm². Each pinhole is available mounted into a black anodized aluminum body which is threaded (0.875-20) to be used with either the 910 Five-axis Spatial Filter or one of the LP-05A Multi-axis Lens Mounts. Such high energy pinhole apertures are available in all wavelength ranges and have a diameter of so about 9.525 mm with a diameter tolerance of about ±0.125 mm. The aperture diameter is about 10±1 μm, the thickness is about 15.24 μm, the thread type is 0.875-20, and can be mounted on 910PH series spatial filter 106 assemblies. The pinhole aperture is made of molybdenum and may have a numerical aperture of 10±1. In one embodiment, the pinhole aperture has a damage threshold of 75 MW/cm2 CW, 700 mJ/cm² with 10 nsec pulses.

In one embodiment, the processor 126 is configured to interface with the electronic display device 112 to provide (e.g., communicate) the digital content 116 for display. In embodiments where the electronic display device 112 comprises an interferometric spatial light modulator based display engine based on an IMOD module, the electronic display device 112 may be configured to conform to industry standards such that the IMOD modules will need no special technological requirements to easily integrate into standard embedded processor based devices including, for examples, mobile devices. In one embodiment, the electronic display device 112 may be configured to support standard industry module communication interfaces such as serial (SPI, I2C) and/or parallel (8080 type), among others.

FIG. 2 is a simplified diagram of an optical system 200 comprising an interferometric spatial light modulator based display engine 212 for use in the digital holographic system 100 shown in FIG. 1. As shown, a volume holographic medium 210 such as a photopolymer film layer is positioned between a laser light source (not shown) and the interferometric spatial light modulator based display engine 212. In one embodiment, the interferometric spatial light modulator based display engine 212 may comprise an IMOD (MIRASOL) module. As previously discussed, the IMOD module technology is used in electronic displays to create a spectrum of through interference of reflected light techniques. The color reflected by the IMOD module may be selected with an electrically switched light modulator comprising a microscopic cavity that is switched on and off using driver integrated circuits similar to those used to address LCD displays. An IMOD based reflective flat panel display includes hundreds of thousands of individual IMOD elements referred to as sub-pixels, where each sub-pixel is a MEMS based device. In a first state an IMOD sub-pixel reflects light at a specific wavelength, and in a second state it absorbs incident light and appears black to the viewer, using a diffraction grating effect. When not being addressed, an IMOD display consumes very little power. Unlike conventional back-lit LCD displays (and like other reflective display technologies), it is clearly visible in bright ambient light such as sunlight. IMOD prototypes are currently capable of 15 frames per second and are expected to reach 30.

The interferometric spatial light modulator based display engine 212 comprises a plurality of pixels each comprising a plurality of sub-pixels 204, 206. The sub-pixels can be controlled to an ON or OFF state to either reflect or absorb, respectively, incoming light rays 202a, 208. As shown, the incident collimated light beam strikes the surface of the volume holographic medium 210 at a predetermined angle of incidence θᵢ. The angle of incidence θᵢ represents the angle of incidence of the laser beam used to illuminate the holographic medium 210 during recording. The light rays 202a, 208 pass through the holographic medium 210 and strike the sub-pixels 204, 206 at the same angle of incidence θᵢ. As shown, the white pixels 204 represent sub-pixels that are turned ON. The light rays 202a that strike the surface of the white sub-pixels 204 are reflected as indicated by light rays 202b shown in dashed line. The dark sub-pixels 206 represent sub-pixels that are turned OFF. When the light rays 208 strike the surface of the dark sub-pixels 206, the incident light rays 208 are absorbed by the dark sub-pixels 206 and no reflection occurs back into the holographic medium 210. An image (text and/or graphic) is displayed by the interferometric spatial light modulator based display engine 212 by controlling the ON/OFF state of the sub-pixels 204, 206. The light rays 202b reflected back into the holographic medium 210 in conjunction with the input light rays 202a, 208 record the digital content (text, graphic, image) displayed by the interferometric spatial light modulator based display engine 212 into the holographic medium 210. In the embodiment shown in FIG. 2, the holographic medium 210 is positioned in direct contact with the surface of the interferometric spatial light modulator based display engine 212 and thus the holographic image will appear on the surface of the holographic medium 210. In other embodiments, the holographic medium 210 may be positioned at a predetermined distance from the surface of the interferometric spatial light modulator based display engine 212. When the holographic medium 210 is positioned a distance d away from the surface of the interferometric spatial light modulator based display engine 212, the holographic image will appear to be at a depth equal to the distance d.

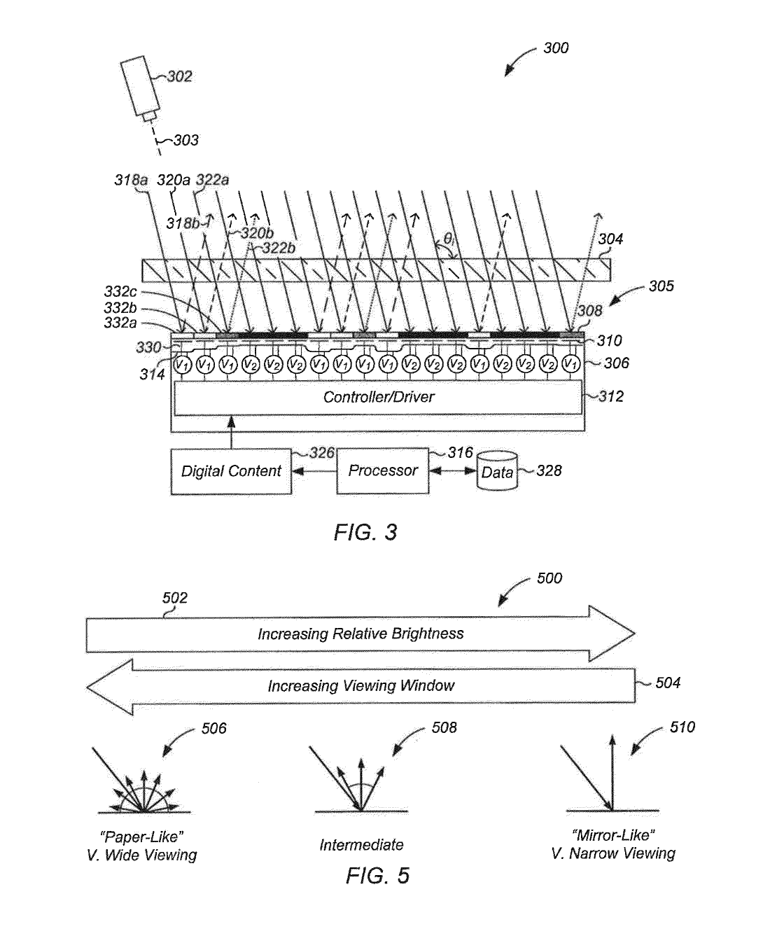

As previously discussed, in one embodiment, the interferometric spatial light modulator based display engine 212 may comprise an IMOD element available from Qualcomm MEMS Technologies of San Diego, Calif. In one configuration, the IMOD element may be a simple, tiny (10-100 microns) micro-electro-mechanical system (MEMS) comprising two conductive plates: (1) a thin film stack on a glass substrate, and (2) a reflective membrane suspended below, as shown and described in more detail hereinbelow in connection with FIG. 3. The reflective membrane responds to a bias voltage applied between the thin film stack and the reflective membrane to hold the reflective membrane in an open state or a collapsed state. When a bias voltage is applied to hold the reflective membrane in an open state, a corresponding sub-pixel reflects a particular color. When a bias voltage is applied that pulls the reflective membrane into a collapsed state, all visible light is absorbed by the corresponding sub-pixel making the sub-pixel element appear black. As shown in FIG. 2, the white sub-pixels 204 have a bias voltage applied that holds the reflective membrane in the open state and thus the IMOD sub-pixel 204 reflects a particular color whereas the dark sub-pixels 206 have an applied voltage that pulls the reflective membrane into the collapsed state such that all visible light is absorbed, making the dark sub-pixel 206 element appear black. A flat-panel electronic display device can be created by employing a plurality of IMOD elements grouped together as pixels and/or sub-pixels. The state of the pixels/sub-pixels can be controlled to reflect or absorb incident light rays by varying the voltage across the IMOD display elements. In this manner, rich and detailed imagery may be display by the IMOD flat-panel display. The imagery displayed by on IMOD flat-panel display can be recorded into the holographic medium 210 by flood laser exposure as previously described.

FIG. 3 is a diagram of one embodiment of a two-dimensional (2D) digital holographic system 300 employing an electronic display device 305 comprising interferometric spatial light modulator based display engine. The system 300 illustrated in FIG. 3 comprises a laser 302 configured to generate a broad light beam 303, which is used to expose a holographic medium 304 during the holographic recording process. The beam 303 is shown as a collimated input beam comprising input rays 318a, 320a, 322a for illustration purposes. As shown, the input rays 318a, 320a, 322a are transmitted through a holographic medium 304 at a predetermined angle of incidence θᵢ, which may be selected to achieve certain holographic effects. Because the holographic medium 304 is optically transmissive, the input rays 318a, 320a, 322a are transmitted through the holographic medium 304 and reach the surface of the electronic display device 305.

In one embodiment, the electronic display device 305 comprises interferometric spatial light modulator based display engine comprising a plurality of IMOD elements MEMS. In one embodiment, the interferometric spatial light modulator based display engine comprises a glass substrate 306 and two conductive plates: (1) a thin film stack 310 and (2) a reflective membrane 314 suspended below. When an applied bias voltage v₁ holds the reflective membrane 314 in the open state, an IMOD sub-pixel elements 332a, 332b, 332c reflect incident light rays 318a, 320a, 322a at a particular wavelength (color) shown as reflected light rays 318b, 320b, 322b. When an applied bias voltage v₂ pulls the reflective membrane 314 into a collapsed state, all visible light is absorbed, making the element appear black. An IMOD display exhibits electro-mechanical memory, referred to as hysteresis, which allows it to maintain its state (open or collapsed). Once moved into the open/collapsed state, a sub-pixel element 332a, 332b, 332c stays there with very low quiescent current.

A pixel in an IMOD based display comprises one or more sub-pixels 332a, 332b, 332c. The sub-pixels 332a-c are individual microscopic interferometric cavities similar in operation to Fabry-Pérot interferometers (etalons), and the scales in butterfly wings, for example. Although a simple etalon consists of two half-silvered mirrors, an IMOD element comprises the reflective conductive membrane 314, which can move in relation to the semitransparent thin film stack 310. With the air gap 330 defined within this cavity, the IMOD behaves like an optically resonant structure whose reflected color is determined by the size of the air gap 330. Application of a bias voltage (v₁, v₂) to the IMOD element creates electrostatic forces which bring the membrane 314 into contact with the thin film stack 310. When this happens, the behavior of the IMOD element changes to that of an induced absorber. The consequence is that almost all incident light is absorbed by the IMOD element and no colors are reflected. It is this binary operation that is the basis for the application of IMOD technology in reflective flat panel electronic display devices 305. Because the electronic display device 305 utilizes light from ambient sources, the brightness of the electronic display device 305 increases in high ambient environments (i.e., sunlight). In contrast, a back-lit LCD display suffers from incident light. For a practical RGB display, a single RGB pixel may be constructed from several sub-pixels 332a, 332b, 332c, because the brightness of a monochromatic pixel is not adjusted. A monochromatic array of sub-pixels 332a, 332b, 332c represents different brightness levels for each color, and for each pixel, there are three such arrays: red (R), green (G), and blue (B).

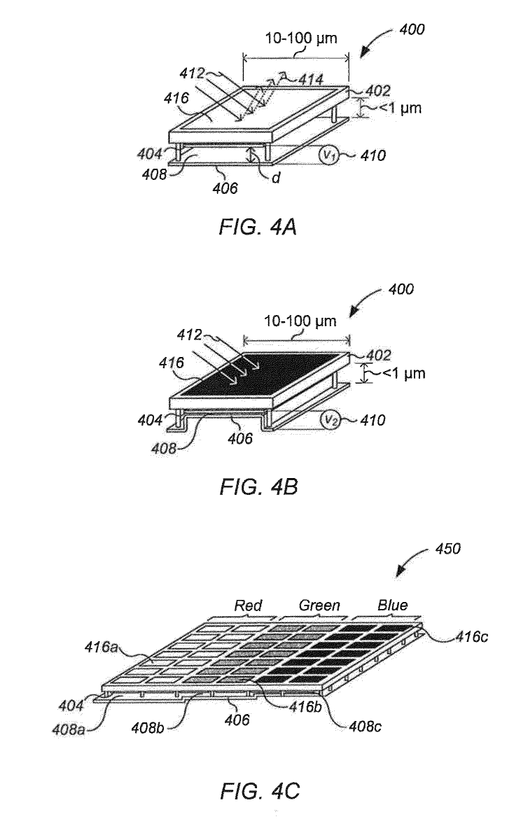

A flat-panel electronic display device 305 may be created using many IMOD elements 308 grouped together as pixel elements or sub-pixel elements 332a, 332b, 332c. In the embodiment illustrated in FIG. 3, for example, the combination of three sub-pixel elements 332a, 332b, 332c form a single pixel. The color reflected the sub-pixel elements 332a, 332b, 332c when biased in the open state depends on the size of the air gap 330 between the thin film stack 310 and the reflective membrane 314. As shown, the air gap 330 distance may be selected such that when biased in the open state, the leftmost sub-pixel element 332a reflects the color red (R), the middle sub-pixel element 332b reflects the color green (G), and the rightmost sub-pixel element 332c reflects the color blue (B). Pixel elements are repeated as groups of sub-pixel elements across the entire area of the electronic display device 305. Varying the bias voltage across the pixel elements formed of RGB sub-pixel elements 332a, 332b, 332c creates rich, detailed color imagery, which can be used to generate holograms by flood laser exposure and controlling the open/collapsed state of the sub-pixel elements 332a, 332b, 332c. It will be appreciated that a pixel element may comprise additional or fewer sub-pixel elements as shown, for example in FIG. 4C.

With reference back now to FIG. 3, a processor 316 or other computer element or embedded system, retrieves digital content 326 (e.g., holographic information such as text, graphics, images) stored in a storage device 328. Digital content 326 can be stored in the storage device 328 using any suitable means including manually uploading the digital content, remotely uploading the digital content, among other techniques. For example, the digital content 326 may be obtained from a remote computer over wide are networks such as the Internet. The storage device 328 may include a database of digital content 326. The digital content 326 is provided to a controller/driver 312 circuit which applies the bias voltages (v₁, v₂) between the thin film stack 310 and the reflective membrane 314 of each individual sub-pixel element 332a, 332b, 332c to display the digital content 326. In this manner, the output display of the IMOD flat-panel electronic display device 305 can be easily and quickly changed to provide custom and unique holographic information which can be used for security or other reasons. The computerized “digital” nature of the process lends itself to high speed web-based production processes. A more detailed explanation of the sub-pixel and pixel elements of the IMOPD flat-panel display and the operation thereof is provided hereinbelow in connection with FIGS. 4A-4C.

Accordingly, FIG. 4A is an illustration of a sub-pixel element 400 of an interferometric spatial light modulator based display in an open state. The sub-pixel 400 may be 10 to 100 μm (microns) wide and less than about 1 μm thick. The sub-pixel element 400 comprises a glass substrate 402 and two conductive plates: a thin film stack 404 and a reflective membrane 406 suspended below the thin film stack 404. In FIG. 4A, the sub-pixel element 400 is shown in the open state at thus there is an air gap 408 between the thin film stack 404 and the reflective membrane 406. A voltage v₁ generated by a voltage source 410 is applied between the thin film stack 404 and the reflective membrane 406 to bias the reflective membrane 406 and hold it in the open state. Accordingly, in the open state, light rays 412 incident on the surface 416 of the sub-pixel element 400 are reflected as rays 414 shown in dashed line form. It will be appreciated that the wavelength (color) of the reflected light rays 414 depends on the distance d between the thin film stack 404 and the reflective membrane 406 that defines the air gap 408. Accordingly, for an RGB type pixel element, a red (R) sub-pixel element may be defined by an air gap 408 distance d₁, a green (G) sub-pixel element may be defined by an air gap 408 distance d₂, where d₂<d₁. A blue (B) sub-pixel may be defined by an air gap 408 distance d₃, where d₃<d₂. The combination of thin film optics and MEMS structure used to create the IMOPD sub-pixel element 400 enables the sub-pixel element 400 to be held at a particular state by a bias voltage v₁. For example, once the bias voltage v₁ is applied between the thin film stack 404 and the reflective membrane 406, the sub-pixel element 400 is set to the open state and is held in the open state by a constant bias voltage v₁, giving the appearance that it is always-on, while drawing very little power. The reflective membrane 406 can be driven to a collapsed state by a short positive-going “write” voltage pulse applied between the thin film stack 404 and the reflective membrane 406, as described below in connection with FIG. 4B.

FIG. 4B is an illustration of the sub-pixel element 400 of FIG. 4A shown in a collapsed state. As described above in connection with FIG. 4A, the IMOD sub-pixel element 400 may be held in an open state at a constant bias voltage v₁ until a short positive-going “write” voltage pulse applied between the thin film stack 404 and the reflective membrane 406 to drive to drive to the collapsed state. As shown, the air gap 408 in the collapsed state is extremely small or eliminated completely. After the “write” voltage pulse is removed, the IMOD sub-pixel element 400 may be held in the collapsed state with the application of a constant bias voltage v₂. As shown in FIG. 4B, in the collapsed state, the surface 416 of the sub-pixel 400 is black and, therefore, absorbs any incident light rays 412. To cause the reflective membrane 406 to pop back up into the open state, a short negative-going “unwrite” voltage pulse may be applied between the thin film stack 404 and the reflective membrane 406. A plurality of sub-pixel elements 400 may be arranged to form a pixel element 450, as described below in connection with FIG. 4C.

FIG. 4C is an illustration of a pixel element 450 of an interferometric spatial light modulator based display. The pixel element 450 is comprised of at least one red (R) sub-pixel, at least one green (G) sub-pixel, and at least one blue (B) sub-pixel. Each of the RGB sub-pixels is comprised of at least one, but usually, multiple sub-pixel elements 416a, 416b, 416c, respectively. Each of the sub-pixel elements 416a, 416b, 416c comprises the thin film stack 404 and the reflective membrane 406. As briefly discussed above, the air gaps 408a, 408b, 408c of the corresponding RGB sub-pixels, respectively, are different in order for the RGB sub-pixels to reflect light at a the desired wavelength (color). In FIG. 4C, the reflective membrane 406 of each RGB sub-pixel is in an open position to show that changing the air gap 408a, 408b, 408c changes the wavelength of light reflected by the sub-pixel elements 416a, 416b, 416c.

Although a particular RGB sub-pixel arrangement is shown for the pixel 450, any suitable sub-pixel arrangement may be employed to achieve particular results. As shown in FIG. 4C, each of the RGB sub-pixels of the pixel element 450 comprises 14 individual sub-pixel elements 416a, 416b, 416c arranged in a 7×2 matrix. It will be appreciated that a particular set of sub-pixels may comprise at least one element and may comprise any suitable number of individual sub-pixel elements 416a, 416b, 416c.

FIG. 5 is a diagram 500 illustrating the trade-off between the brightness and viewing window of a holographic image. Because the amount of light falling on a hologram for any given lighting condition is fixed, the integrated amount of light (over all viewing angles) is fixed according to the holographic and optical properties of the holographic medium (e.g., Δn, thickness, absorption, etc. . . . ). Increased brightness (at a specific viewing position) can then be improved only by restricting the viewing window. As shown in FIG. 5, for example, relative brightness 502 increases from left to right whereas viewing window 504 increases from right to left. At the extremes, minimum relative brightness 502 and maximum viewing window 504 produces a hologram having a paper-like 506 appearance; diffused but with a very wide viewing angle. Maximum relative brightness 502 and minimum viewing window 504 produces a hologram having a mirror-like 510 (specular) appearance; very bright but with narrow viewing angle. Intermediate relative brightness 502 and viewing 504 produces an intermediate 508 hologram having a somewhat diffuse hologram with a brightness and viewing angle suitable for most holographic applications.

The hologram is an optical variable device and will disappear and appear as the substrate or card containing the hologram is tilted or twisted. Accordingly, by selecting a suitable relative brightness 502 and viewing window 504 a hologram can be designed to have a paper-like 506 appearance or a specular mirror-like appearance 510 or something in between. For example, when a paper-like 506 hologram is illuminated by incoming light, the holographic region redirects the light in a large range of angles such that the hologram can be viewed from straight above the substrate and from the sides of the substrate. Thus a paper-like 506 holographic image can be viewed in substantially every direction from the normal direction because light is redirected in every direction much like a paper-based image or printed image. This is similar to an image on a piece of paper that can be viewed from substantially anywhere. Holographic images can be made more mirror-like 510 such that the holographic image reflects the incoming light predominately at one angle or one area so that when properly illuminated, the holographic image disappears when not being viewed at the proper angle from the proper position. When a mirror-like 510 holographic image is viewed from the correct position, however, a very bright holographic image is formed by the light. Such mirror-like 510 holograms provide a very high contrast and make very bright holographic images having glowing-like features resembling a specular or mirror surface with a bright light shining onto it. The glare and shining of the mirror-like hologram 510 provides very bright and very obvious holographic features that can be easily detected when the substrate is tilted or twisted. For example, the holographic image flickers, is very bright and noticeable, and appears to jump out of the substrate to make it very easy to see, recognize, and notice by observers.

Another advantage of using the IMOD technology to generate holograms is that because it is a reflective technology with very high reflectivity, it is very suitable for making bright, reflective, specular or mirror-like 510 holographic images. Another advantage provided by IMOD technology for 2D imagery is color specificity. Other reflective technologies, for example, such as LCD or micro-mirror devices, do not provide color specificity to each of the pixels. In reflective LCDs the polarization state must be changed, which is problematic when producing hologram recordings so additional components and optical elements are required to obtain an adequate recordings with an LCD type display. Nevertheless, the LCD elements tend to be more scattering or more diffuse just by their nature. When a light is shined onto an LCD display or onto a micro-mirror device light is reflected such that all of the colors of the light are reflected back off of each pixel and provide a grey scale image but it cannot provide color imagery directly from a single device. Although digital projection techniques, such as digital theater projectors, for example, may be employed in LCD or micro-mirror based devices to produce color imagery, such techniques often employ a three chips designs and the implementation quickly becomes complicated. In contrast, the IMOD technology employs sub-pixels to produce individual RGB colors. The IMOD technology is interference based and produces colors that have very strong peaks at specific wavelengths.

Because all volume holographic recordings have to be done by laser, there is substantially no way to do it with a white light or even an LED light. In other words, there is a very specific wavelength of light directed to the image processing site to produce the holograms. This is very complimentary to the fact that the IMOD technology is designed and built to be highly reflective at the laser wavelength for an on-pixel. A mirror-like 510 hologram can be made more diffused by positioning a diffuser in front of the holographic medium during exposure. Also, it is possible to add a diffusor sheet between the IMOD reflective display and the holographic medium.

It should also be noted that the diffraction of an holographic image is an additive process (unlike the subtractive process of absorption used in standard printing). As white paper is a nearly perfect broad-spectrum diffuse reflector, there is no way for any hologram to be brighter than a white paper background unless viewing angle is restricted, as the hologram does not generate light but only redirects it. Accordingly, in one implementation, a dark (black) backing may be used for holograms with large viewing angle. In another implementation, a restricted viewing angle (often mirror-like) may be used with a bright background.

Although the above described techniques provide examples of direct holographic recording of digital content displayed on an electronic display device comprising an interferometric spatial light modulator based display, such as an IMOD module, such direct recordings enable 2D imagery. Often, however, the 2D recordings are referred to as 2D/3D because the text, graphics, or images recorded are two-dimensional but can be seen “floating” above or below the plane of the holographic medium, which gives a 3D effect not possible with conventional graphics. This is clearly one type of digital holography, because digital content can be displayed and recorded in the holographic medium. An example application of such usage might be recording “floating” individual serial numbers on a brand protection label. As the holographic recording system positions the film, a new serial number, for example, may be displayed and recorded into the holographic medium.

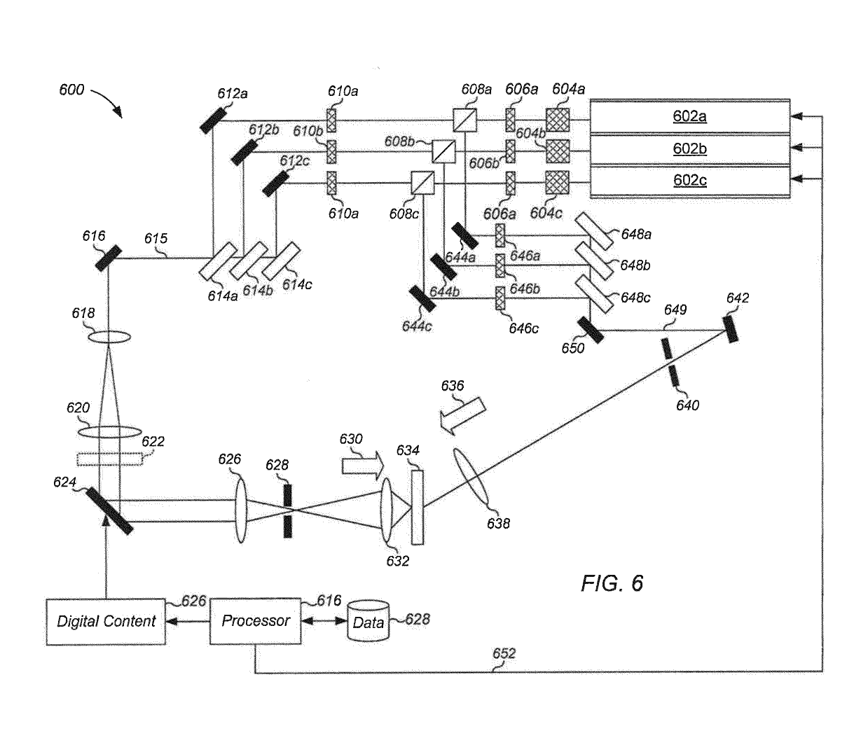

In the field of holography, the term digital holography is more commonly used to refer to 3D images created by digital processes. There are many variants of such 3D techniques, ranging from stereograms that show parallax in one direction only (usually horizontal) by recording stripes of image scenes to fully synthetic computation of hologram structure from 3D computer models. Many of these processes use holographic printers to write individual pixels or stripes in a volume holographic medium using complex optical imaging systems. To create the images that are recorded into the holographic medium film, the core of these imaging systems often employ LCDs. In contrast, an IMOD display provides several benefits ranging from improved light efficiency, better control over diffuse character of the light because the IMOD module is capable of more highly specular (less scattered) light versus the LCDs, color control, refresh rates, among other advantages. A technique for creating 3D holographic images employing an IMOD display is described below in connection with FIG. 6.

FIG. 6 is a diagram of one embodiment of a three-dimensional (3D) digital holographic system 600 for recording high-density full-color full-parallax holographic stereograms employing an interferometric spatial light modulator based display engine. The digital holographic system 600 shown in FIG. 6 is one embodiment of a digital holographic system that may be employed to record a three-dimensional (3D) high-density full-color full-parallax digital holographic stereogram on a holographic medium 634 (e.g., holographic plate) located at an image processing site remote from an electronic display device 624. In the illustrated embodiment, the image processing site comprises an x-y stage holographic plate with the holographic medium 634 positioned thereon. Digital content 626 (e.g., holographic information such as text, graphics, images) is retrieved from a storage device 628 by a processor 616. For example, the digital content 626 may be obtained from a remote computer over wide are networks such as the Internet. The storage device 628 may include a database of digital content 626. The digital content 626 is provided to the electronic display device 624, which comprises an interferometric spatial light modulator based display engine such as, for example, a flat-panel IMOD display module. The digital content 626 displayed by the electronic display device 624 is optically transmitted to the holographic medium 634 at the image processing site. Digital content 626 can be stored in the storage device 628 using any suitable means including manually uploading the digital content, remotely uploading the digital content, among other techniques.

The basic elements of the system 600 shown in FIG. 6 will now be described. In embodiments associated with full-color applications, the system 600 comprises three lasers 602a, 602b, 602c to generate three separate light beams at three different peak wavelengths perceived as red (R), green (G), and blue (B) light. The three-separate colored light beams are transmitted through various optical elements of the system 600 and ultimately emerge as a first single object beam 630 and a second single reference beam 636 to expose the holographic medium 634 at the image processing site. In one embodiment, the first laser 602a may be a Helium-Neon (He—Ne) laser that outputs a red (R) beam at a peak wavelength of about 633 nm. The second and third lasers 602b, 602c produce the green (G) and the blue (B) beams, respectively. In one embodiment, the green (G) and blue (B) 602b, 602c lasers may be diode-pumped solid-state (DPSS) lasers made by pumping a solid gain medium to a ruby or a neodymium-doped yttrium aluminum garnet (YAG) crystal with a laser diode to produce a light beam at the desired wavelength. In various embodiments, the DPSS lasers 602b, 602c provide advantages such as compactness and efficiency over other types of lasers. High power DPSS lasers have replaced ion lasers and flash lamp-pumped lasers in many scientific applications, and are now appearing commonly in green (G) and other colors such as blue (B). In the digital holographic system 600, the second laser 602b may be configured to generate a green (B) beam at a peak wavelength of 532 nm and the third laser 602c may be configured to generate a blue (B) beam at a peak wavelength of 473 nm. In operation, the RGB light beams produced by the respective lasers 602a, 602b, 602c are optically processed by several optical elements as discussed next. The operation of the lasers 602a, 602b, 602c is also controlled by the processor 616, which coordinates activation of the lasers 602a, 602b, 602c with the displaying of the digital content on the electronic display device 624, and positioning of the holographic medium 634 at the image processing site.

Each one of the RGB light beams produced by the respective lasers 602a, 602b, 602c are optically processed in a similar manner. As the RGB light beams emerge from the respective lasers 602a, 602b, 602c they are coupled through respective shutters 604a, 604b, 604c. In one embodiment, the shutters 604a-c may comprise an acousto-optic modulator (AOM), also called a Bragg cell, which uses the acousto-optic effect to diffract and shift the frequency of the input light beam using sound waves (usually at radio-frequency). In general, an AOM shutter may comprise a piezoelectric transducer attached to a material such as glass where an oscillating electric signal drives the transducer to vibrate, creating sound waves in the glass. By moving periodic planes of expansion and compression and changing the index of refraction, the shutters 604a-c can be made to produce pulsed output light beams.

The pulsed RGB light beams from the shutters 604a-c are provided to respective wave plates 606a, 606b, 606c. In one embodiment, the wave plates 606a-c are λ/2 wave retarders. It will be appreciated by those skilled in the art, that the wave plates 606a-c may be configured to alter the polarization state of the light wave traveling through it. Accordingly, the wave plates 606a-c shift the phase of the respective RGB light beams between two perpendicular polarization components of the light wave. In one implementation, the wave plates 606a-c may comprise a birefringent crystal with a suitably chosen orientation and thickness where the crystal is cut so that the “optic axis” is parallel to the surfaces of the wave plate 606a-c. Light polarized along the “optic axis” travels through the crystal at a different speed than light with the perpendicular polarization, creating a phase difference. In the embodiment represented by the system 600 illustrated in FIG. 6, the λ/2 wave retarders wave plates 606a-c retard one polarization by half a wavelength, or 180 degrees, and changes the polarization direction of linear polarized light.

The λ/2 wave retarded light beams emerging from the wave plates 606a-c are provided to respective beam splitters 608a, 608b, 608c where the RGB light beams are split into two separate optical paths. A first optical path produces the object beam 630 and the second optical path produces the reference beam 636. Along the object beam 630 optical path, the light beams exiting the beam splitters 608a-c are directed to a second set of wave plates 610a-c similar to the first set of wave plates 606a-c. The second set of wave plates 608a-c, which in one embodiment are λ/2 wave retarders, retard the polarization by another half a wavelength, or 180 degrees and changes the polarization direction of linear polarized light. Accordingly, the polarization of the light beams emerging from the second set of wave plates 610a-c is in phase with the polarization of the light beams entering the first set of wave plates 606a-c. The light beams that exit the second set of wave plates 610a-c are reflected by corresponding mirrors 612a, 612b, 612c to a set of corresponding RGB dichroic mirrors 614a, 614b, 614c. The dichroic mirrors 614a-c each accurately reflect a particular color of light. Thus, a blue (B) dichroic mirror 614c reflects blue light which is combined with the green light reflected by a green (G) dichroic mirror 614b. The combined green-blue light beam is then combined with the red light beam reflected by a red (R) dichroic mirror 614a. A combined RGB light beam 615 emerges from the dichroic mirrors 614a-c. Alternatively the dichroic mirror 614c can also be replaced by a regular mirror.

The combined RGB light beam 615 may be reflected by a mirror 616, transmitted through an objective lens 618, and then through a first collimating lens 620. The collimated light beam impinges on the front face of the electronic display device 624 and is reflected off the front face of the display 624 to a second collimating lens 626. Accordingly, the information being displayed by the display is transmitted to a second collimating lens 626. In the context of the digital holographic system 600, the information being displayed by the electronic display device 624 at the time the collimated beam hits the front face of the electronic display device 624 is digital content 626 which is to be recorded in the holographic medium 634 at the image processing site. As previously discussed, the digital content 626 (text, graphics, images) is retrieved from the storage device 628 by the processor 616 and is provided to the electronic display device 624 as digital information and the electronic display device 624 displays the digital content 626. In one aspect, the electronic display device 624 comprises an interferometric spatial light modulator based display engine such as IMOD module as previously discussed in connection with FIGS. 1-4. In one embodiment, an optional diffuser 622, shown in phantom, may be interposed between the display 624 and the first collimating lens 620 to diffuse the image depending on the desired image appearance. As previously discussed, the IMOD based electronic display device 624 produces highly reflective specular holographic images and to increase the viewing angle the diffuser 622 may be employed. From the second collimating lens 626, the light beam is directed through an aperture 628 and finally through an objective lens 632. The objective beam 630 is output by the objective lens 632 and exposes the holographic medium 634 at the image processing site.

The light beams emerging from the beam splitters 608a-c on the reference beam 636 path are reflected by corresponding mirrors 644a, 644b, 644c to corresponding wave plates 646a, 646b, 646c (λ/2 wave retarders) to retard or shift one polarization of the light beams by half a wavelength, or 180 degrees, and change the polarization direction of the linear polarized light. The retarded light beams are then reflected off corresponding RGB dichroic mirrors 648a, 648b, 648c and another mirror 650 to form a combined RGB light beam 649. Alternatively the dichroic mirror 648c can also be replaced by a regular mirror. The combined RGB light beam 649 is reflected again by another mirror 642 and is transmitted through an aperture 640. The reference beam 636 is then transmitted by a lens 638 and exposes the holographic medium 634 at the image processing site. The result is a 3D high-density full-color full-parallax holographic stereogram with the digital content 626 displayed by electronic display device 624.

Other configurations of the system are possible to one skilled in the art to produce 3D holographic stereograms with a single parallax from digital content 626 displayed by electronic display device 624 or to produce 2D holographic images. Single-parallax images may be preferable for some applications where full parallax is not needed and where speed of production is more critical. Although 2D images can be so produced by non-holographic means, holographic 2D images are often desired in the areas of security and brand protection, where their distinct look cannot be recreated with conventional printing.

Having described the various elements of the digital holographic system 600, a method of processing a holographic image using the system 600 will now be described. Accordingly, the processor 616 retrieves digital content 626 from a storage device 628. The digital content 626 corresponds to holographic information to be recorded into the holographic medium 634 at the processing site and may comprise text, graphics, images, and any combination thereof. Upon retrieving the digital content 626 from the storage device 628, the processor 626 uploads the digital content 626 to the electronic display device 624. The processor 626 may be coupled to the electronic display device 624 by wired or wireless communication means and thus the method of uploading the digital content 626 to the electronic display device 624 may vary accordingly, without limitation. As previously discussed, the electronic display device 624 may comprise an IMOD module to render the digital content 626 by controlling the on/off state of pixel and sub-pixel elements of the electronic display device 624. Upon uploading the digital content 626 to the electronic display device 624, it is displayed, and the processor 616 then controls the operation of the lasers 602a-c by way of feedback loop 652. The feedback loop 652 communicatively couples the processor 616 to the lasers 602a-c. The processor 616, for example, may be operative to activate (turn on) the lasers 602a-c to expose the holographic medium 634 at the image processing site in order to record the digital content 626 being displayed by the electronic display device 624 into the holographic medium 634. Upon exposing the holographic medium 634 and recording the digital content 626 into the holographic medium 634, the processor 616 is operative to control the positioning of a new unexposed portion of holographic medium 634 at the image processing site, uploading new digital content 626 to the electronic display device 624, displaying the digital content 626, and activating the lasers 602a-c to expose the new portion of the holographic medium 634 and record a new hologram. The process may be repeated as desired, displaying unique digital content 626 for each hologram being recorded in a blank unexposed holographic medium 634. In this manner, unique holograms can recorded in holographic media at production speeds without stopping the process to change out a holographic embosser, for example. As previously discussed, in some embodiments more than one hologram may comprises the same digital content whereas in other embodiments, each hologram may comprise unique digital content, without limitation. It will be appreciated that the processor 616 may be coupled to the lasers 602a-c by wired or wireless communications means and thus the communication techniques may vary accordingly, without limitation.

The digital content 626 may comprise any information to be recorded in the holographic medium 634. For example, the digital content 626 may comprise a photographic image of an individual's face, signature, identification information, component serial number, logo or other recognizable trade insignia, and the like. In short, any unique identification information that can be digitally stored in the form of digital content 626 in the storage device 628, uploaded and displayed by the electronic display device 624 can be recorded into the holographic medium 634 using the digital holographic system 600 of FIG. 6.

Additionally, although the digital holographic system 600 of FIG. 6 employs three separate lasers 602a, 602b, 602c to produce a combined RGB colored beam 615 to expose the holographic medium 634, it will be appreciated that any suitable number of lasers may be employed depending on the holographic effect to be achieved. For example, in one implementation of the system 600, a single laser may be employed and the number of optical elements can be reduced accordingly to accommodate a single beam. In some implementations, two lasers may be employed, and in still other implementations more than three lasers may be employed.

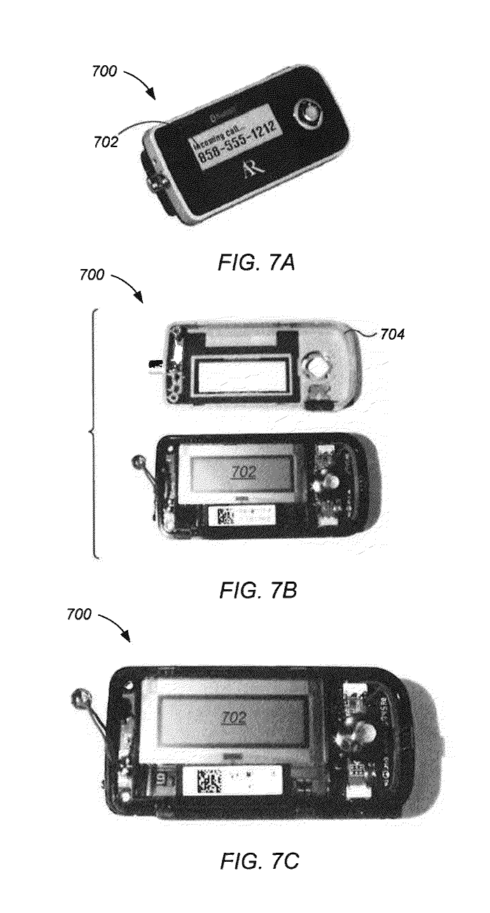

Various apparatus, systems, and methods have been disclosed in connection with FIGS. 1-6 for generating holograms using an electronic display device comprising an interferometric spatial light modulator based display engine to display digital content to be recorded in a holographic medium. Test results of image holograms generated in accordance with the disclosed embodiments were obtained using a commercially available device as shown in FIGS. 7A-C, are now presented. Holographic images were generated using a commercially available product having a display comprising an interferometric spatial light modulator based display engine such as an IMOD based display as illustrated in FIGS. 7A-C, With reference now to FIGS. 7A-C, the Acoustic Research ARWH1 Bluetooth Headset 700 is a product presently commercially available in North America that employs an IMOD display 702 commonly known under the trade name MIRASOL. A clear plastic cover 704 piece in the top cover of the headset was removed because it was not stable enough to obtain a suitable hologram. Therefore, the plastic cover 704 was removed to obtain direct access to the IMOD display 702. The ARWH1 Bluetooth headset 700 uses a 1.1″ Bichrome MIRASOL® display 702. The display 702 includes 129×40 pixels with a pixel density of 129 pixels per inch (ppi). The active area of the display 702 is 25.09×7.84 mm. The pixel pitch of the display 702 is 0.196 mm. The two pixel states of the display 702 are green or black. As integrated in device, the display 702 includes a diffuser which changes the reflected light from specular reflection to a more diffuse reflection. In many embodiments, such a diffuser would not be included.

Several hologram samples were generated using the IMOD display 702 unit. Although, the IMOD display 702 unit has an integrated diffuser film positioned on the display 702, several holograms were generated with the diffuser and others were generated without the diffuser. As previously discussed, a diffuser may be employed to generate holographic images where a “paper-like” diffuse appearance is desired, even though the diffuser may limit recording options. With the diffuser removed from the display 702, the several holograms were recorded to show “mirror-like” specular reflectance effects. Several holograms were generated by direct adherence to the display 702 whereas other holograms were generated by interposing optical elements, such as a glass wedge, between the holographic medium (e.g., film) and the display 702. In the former, the reflected light is identical to the glare angle, so hologram viewing is difficult. In the latter, the glass wedge shifts the resulting hologram from the glare angle, so that a bright specular hologram is formed that can be seen without looking at the glare. For different applications, embodiments using any of the above approaches may be employed, without limitation.

Having described various embodiments of digital holographic systems, the disclosure now turns to at least one non-limiting example of a computer environment in which the digital holographic process may be implemented. The digital holographic process may be controlled by hardware, software, and/or combinations thereof. If the process is to be controlled by software, the software may reside in software memory. The software in memory may include an ordered listing of executable instructions for implementing logical functions (i.e., “logic” that may be implement either in digital form such as digital circuitry or source code or in analog form such as analog circuitry or an analog source such an analog electrical, sound or video signal), may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer-readable medium selectively may be, for example but not limited to, an electronic, magnetic, optical, electromagnetic, infrared, or semiconductor system, apparatus, device, or propagation medium. More specific examples “a non-exhaustive list” of the computer-readable medium would include the following: an electrical connection “electronic” having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

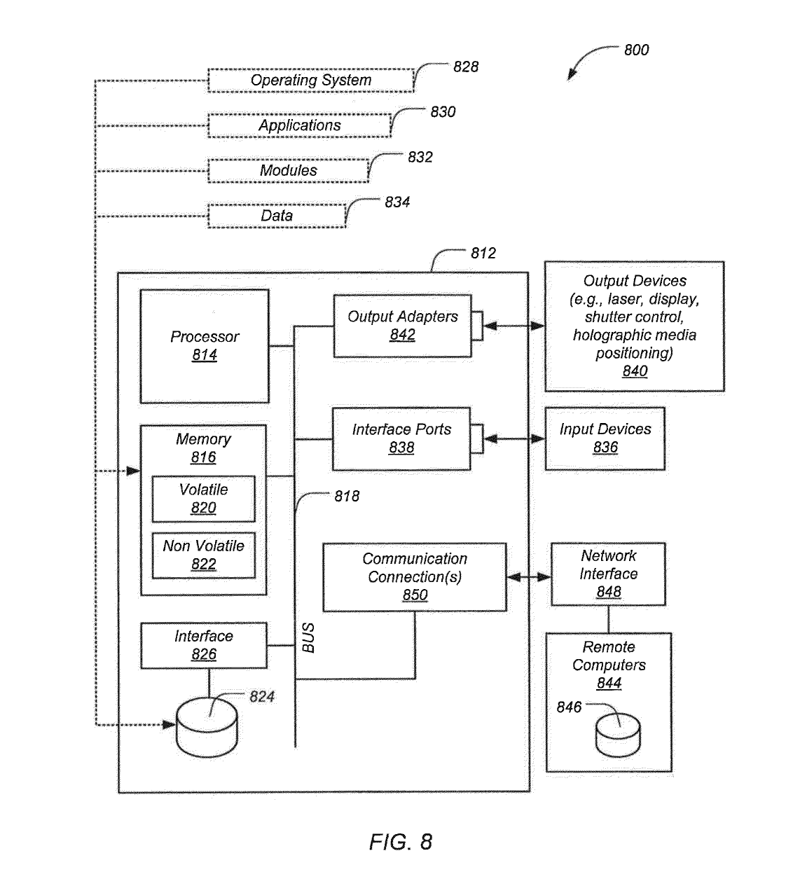

FIG. 8 illustrates a computer system which may be employed to control a digital holographic process in accordance with the present disclosure. In one embodiment, the computer system 800 includes a processor 814, a system memory 816, and a system bus 818. The system bus 818 couples system components including, but not limited to, the system memory 816 to the processor 814. The processor 814 can be any of various available processors. Dual microprocessors and other multiprocessor architectures also can be employed as the processor 814. It will be appreciated that the computer system 800 may be a general purpose computer specifically programmed to control the digital holographic process, may be a dedicated embedded computer system, an industrial controller, or any combination thereof.

The system bus 818 can be any of several types of bus structure(s) including the memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), Small Computer Systems Interface (SCSI) or other proprietary bus.

The system memory 816 includes volatile memory 820 and nonvolatile memory 822. The basic input/output system (BIOS), containing the basic routines to transfer information between elements within the computer system 812, such as during start-up, is stored in nonvolatile memory 822. For example, the nonvolatile memory 822 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. Moreover, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The computer system 812 also includes removable/non-removable, volatile/non-volatile computer storage media for storing digital content. FIG. 8 illustrates, for example a disk storage 824. The disk storage 824 includes, but is not limited to, devices like a magnetic disk drive, floppy disk drive, tape drive, Jaz drive, Zip drive, LS-60 drive, flash memory card, or memory stick, among others. In addition, the disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface 826 is typically used. Digital content can be stored in the disk device 824 using any suitable means including manually uploading the digital content, remotely uploading the digital content, among other techniques. The disk storage 824 may include a database of digital content. Digital content may be obtained from the remote computer 844 over wide area networks such as the Internet.

It is to be appreciated that FIG. 8 describes software that acts as an intermediary between users and the basic computer resources described in a suitable operating environment. Such software includes an operating system 828. The operating system 828, which can be stored on the disk storage 824, acts to control and allocate resources of the computer system 812. System applications 830 take advantage of the management of resources by the operating system 828 through program modules 832 and program data 834 stored either in the system memory 816 or on the disk storage 824. It is to be appreciated that various components described herein can be implemented with various operating systems or combinations of operating systems.

A user may enter commands or information into the computer system 812 through input device(s) 836. The input devices 836 may include, without limitation, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processor 814 through the system bus 818 via interface port(s) 838. The interface port(s) 838 include, for example, a serial port, a parallel port, a game port, and a universal serial bus (USB). The output device(s) 840 use some of the same type of ports as input device(s) 836. Thus, for example, a USB port may be used to provide input to the computer system 812 and to output information from the computer system 812 to an output device 840. An output device 840 may comprise, without limitation, a laser, display, shutter control, holographic media positioning system, among other devices. An output adapter 842 is provided to illustrate that there are some output devices 840 like monitors, speakers, and printers, among other output devices 1540 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

The computer system 812 can operate in a networked environment using logical connections to one or more remote computers, such as the remote computer(s) 844. The remote computer(s) 844 can be a personal computer, a server, a router, a network PC, a workstation, a microprocessor based appliance such as a laser, display, shutter control, holographic media positioning system, a peer device or other common network node and the like, and typically includes many or all of the elements described relative to the computer system 812. For purposes of brevity, only a memory storage device 846 is illustrated with the remote computer(s) 844. The remote storage device 846 also may include digital content for recording onto holograms. The remote computer(s) 844 is logically connected to the computer system 812 through a network interface 848 and then physically connected via a communication connection 850. The network interface 848 encompasses communication networks such as local-area networks (LAN) and wide area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

The communication connection(s) 850 refers to the hardware/software employed to connect the network interface 848 to the bus 818. Although the communication connection 850 is shown for illustrative clarity inside the computer system 812, it can also be external to the computer system 812. The hardware/software necessary for connection to the network interface 848 includes, for example purposes only, internal and external technologies such as, modems including regular telephone grade modems, cable modems and DSL modems, ISDN adapters, and Ethernet cards.

Communications between the computer system 812 and various elements of the digital holographic systems such as lasers, displays, shutter control devices, holographic media positioning systems, as described herein, may be implemented using wireless communication techniques. In various embodiments, data communications functionality may be implemented in accordance with different types of wireless systems. Examples of wireless systems may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), CDMA-2000, Universal Mobile Telephone System (UMTS) systems, WiMAX (Worldwide Interoperability for Microwave Access, LTE (Long Term Evolution) and so forth.

In various embodiments, the computer system 812 may be configured to provide data communications functionality in accordance with different types of wireless network systems or protocols. Examples of suitable wireless network systems offering data communication services may include the Institute of Electrical and Electronics Engineers (IEEE) 802.xx series of protocols, such as the IEEE 802.1a/b/g/n series of standard protocols and variants (also referred to as “WiFi”), the IEEE 802.16 series of standard protocols and variants (also referred to as “WiMAX”), the IEEE 802.20 series of standard protocols and variants, and so forth. The computer system 812 also may utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electromagnetic induction (EMI) techniques. An example of EMI techniques may include passive or active radio-frequency identification (RFID) protocols and devices.

In various embodiments, the computer system 812 is configured to couple to a communication interface to access the cloud (Internet). The communication interface may form part of a wired communications system, a wireless communications system, or a combination of both. For example, the computer system 812 may be configured to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The computer system 812 may be arranged to communicate information over one or more types of wireless communication links such as a radio channel, satellite channel, television channel, broadcast channel infrared channel, radio-frequency (RF) channel, WiFi channel, a portion of the RF spectrum, and/or one or more licensed or license-free frequency bands. In wireless implementations, the computer system 812 may comprise one more interfaces and/or components for wireless communication such as one or more transmitters, receivers, transceivers, amplifiers, filters, control logic, wireless network interface cards (WNICs), antennas, and so forth.

### Examples

The present invention is further illustrated, but is not to be limited, by the following examples. In the examples of the invention described herein, the following materials were used:
BAYFOL HX 102: A full color sensitized photopolymer film for volume holographic recordings available from Bayer MaterialScience AG, Leverkusen, Germany. The film has an effective photopolymer film thickness of approximately 16 μm.
BAYFOL HX 103: A green sensitized photopolymer film for volume holographic recordings available from Bayer MaterialScience AG, Leverkusen, Germany. The film has an effective photopolymer film thickness of approximately 16 μm.

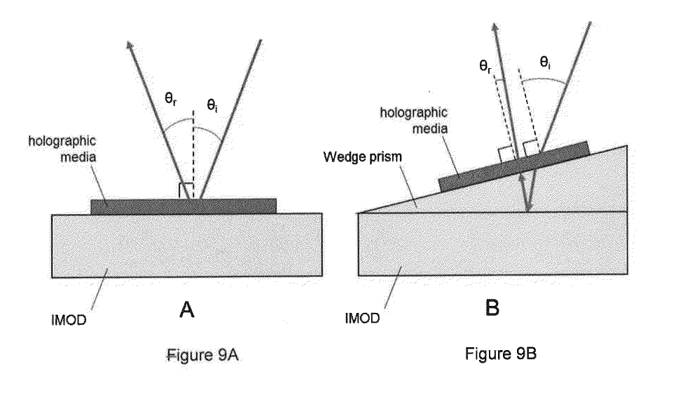

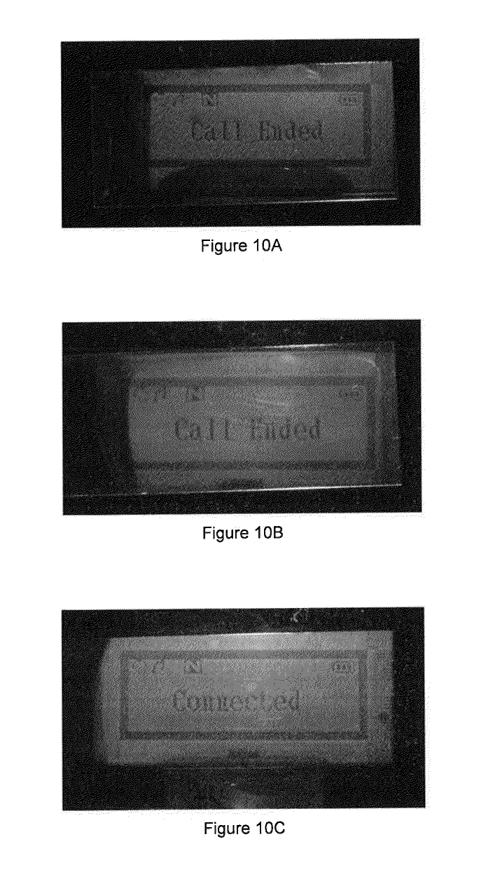

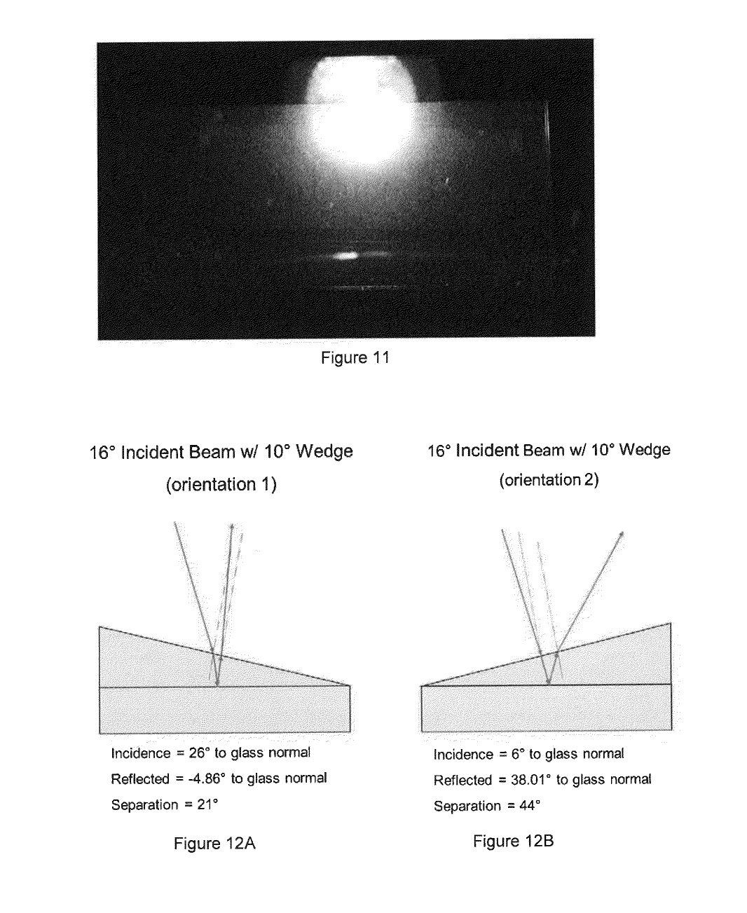

TABLE 1 below summarizes the details of the examples where reflection holograms were recorded in BAYFOL HX 102 or BAYFOL HX 103 by uploading digital content to the display 702 and recording as described in FIGS. 9A and 9B. Angle θᵢ is the angle of incidence of the laser beam used to illuminate the holographic medium (e.g., film) during recording. “Diffuser” indicates presence of a diffuser film as received or recordings done on the IMOD display 702 after removing the diffuser film, “Wedge” indicates whether a 10° wedge prism was used or not during recording. Photographs of the resulting holograms are shown in FIGS. 10 and 11.

TABLE 1

| | Holo- | | | | |
|---|---|---|---|---|---|
| | graphic | | | | |
| | Medium | | With | | Display |
| Example | (BAYFOL | Angle, | Affixed | Wedge | (Digital |
| No. | Film) | θᵢ | Diffuser | Prism Used | Content) |
| 1 | HX 102 | 0° | YES | NO | “Call Ended” |
| 2 | HX 102 | 45° | YES | NO | “Call Ended” |
| 3 | HX 103 | 0° | YES | NO | “Connected” |
| 4 | HX 103 | 0° | NO | NO | “Volume 5” |
| 5 | HX 103 | 16° | NO | YES- | “Connected” |
| | | | | orientation 1 | |
| 6 | HX 103 | 16° | NO | YES- | “5129900043” |
| | | | | orientation 1 | |
| 7 | HX 103 | 16° | NO | YES- | “5129900043” |
| | | | | orientation 2 | |

The sample holograms, the results of which are summarized in TABLE 1, except for the wedge samples may best be viewed when the incident light comes onto the sample at approximately the same angle as the recording angle (θᵢ). Depending on the wedge orientation, the wedge samples are best viewed when illuminated with light coming in at either approximately 26° from normal (for orientation 1) or approximately 40° from normal (for orientation 2) while viewing straight-on (near normal). For those samples generated with a diffuser, a bright point-like source or diffuse source works well. For those samples without a diffuser, a diffuse source makes the image more easily viewed (but spot-lighting can give much brighter images). It should be appreciated that any digital content shown on the display 702 can be copied into the holographic medium.

The wedge was included in these proof-of-principle examples to shift the reconstructed light beam away from the normally symmetric reflected beam that a typical mirror or, similarly. IMOD display would display. The difference between a reflective hologram produced by an IMOD display (or mirror) alone and one produced with a prism or other angular-shifting optic is depicted in FIGS. 9A and 9B.

As shown in FIGS. 9A and 9B the difference between the holographic recording of a mirror-like element, such as an IMOD, with (FIG. 9B) and without (FIG. 9A) the use of an angularly shifting optic, such as a wedge prism. On the left (FIG. 9A), the angle of reflection (Or) will always equal the angle of incidence (θᵢ), regardless of angle chosen as is governed by the law of reflection. Reconstruction of such mirror-like holograms can be problematic for some applications, because the image will reconstruct at the same angle as the glare angle from the light source (typically due to surface reflections from the film or other neighboring layers). When a wedge prism is used, the angles are shifted by refraction in the wedge, thereby allowing creation of an asymmetric holographic mirror (θr≠θi). This allows holographic mirrors to be created that do not reconstruct at the same angle as the glare, thereby improving viewability.

As detailed above, the IMOD display from the Acoustic Research Bluetooth headset has a diffuser film affixed to it once the outer plastic cover is removed. A simple demonstration of the suitability of the display to be used for hologram recording is shown in FIGS. 10A-C, which shows the resulting hologram produced by laminating a piece of BAYFOL HX 102 film on top of the integrated diffuser film and exposing with a green laser beam. In FIGS. 10A-C, a point-like halogen light source was used to illuminated the sample; however, the hologram recorded the diffuse IMOD display, so the reconstructed image can be seen over a wide range of angles, thus eliminating the need for viewing at the glare angle.

FIG. 10A is a photograph of sample D0110211L; FIG. 10B is a photograph of sample D0110211Q; and FIG. 10C is a photograph of sample D0110211U. All of these holograms were recorded from the IMOD display before removal of the integrated diffuser included in the commercial display, and the holograms were relaminated to a glass slide afterward. All photos were taken with a point-like light source (a tungsten halogen lamp) and a black background. Regardless of the material used (BAYFOL HX 102 film or BAYFOL HX 103 film) or the recording incident angle, similar high-quality diffuse holograms were produced.

Incidentally, it is quite likely that the commercial IMOD displays include the diffuser for the same reason in the device—if it was not included, the user would have considerable difficulties in viewing the screen under non-diffuse lighting conditions (i.e. sunlight on a clear day, illumination with a halogen desk lamp, etc. . . . ) because the displays image would only be seen at angles that correspond to the glare from the reflected light source. Viewing such an image is not only difficult, but it requires the user to view the device in a manner contrary to human nature—intentionally looking into the glare instead of normally turning our view or the object to avoid such glare.

In FIG. 11, this effect is clearly seen in the photograph of the reconstructed hologram produced from direct recording of the IMOD display without a diffuser film. For this sample, the diffuser sheet that is integrated into the commercially available IMOD display was removed from the top of the IMOD device. It appeared to have been affixed to the display with an adhesive, but it was removable with careful peeling away from the device. The surface of the display was then cleaned to remove traces of adhesive or other contaminants prior to subsequent recordings. In Figure BBBB, the image of the words “Volume 5” can be seen, but to reconstruct this image with a point-like light source (such as the halogen lamp used in this image), the sample and viewing must be oriented such that the glare from the light source is close to coincident with the hologram. This can be avoided, if desired, by addition of a diffuser optic. This diffuser function can be recorded in the hologram (as shown in FIGS. 10A-C) or can be incorporated as a separate optical element in the optical path of a hologram recorded without the diffuser.

FIG. 11 provides a photograph of sample D110214D using a point-like light source (tungsten halogen lamp). This sample was produced from the IMOD display after removal of the diffuser film affixed in the commercially available display. Although the IMOD display of “Volume 5” can be seen in the image, the problem of the glare from the light source is quite evident. In this example, the white glare is considerably brighter than the holographic image, so the image appears relatively dim.

Addition of a wedge prism to the IMOD display during recording can allow the production of an asymmetric holographic mirror, in which the reconstructed light from the hologram is shifted angularly away from the glare angle. Using a 10° wedge, several tests were made using two orientations—see FIGS. 12A and 12B. For these tests, a 1″ diameter circular wedge prism was used.

FIGS. 12A and 12B provide a schematic of the two orientations used for recording with the wedge prism. (FIG. 12A, orientation 1). The normal of the wedge glass surface is away from the incident beam. The resulting hologram formed from this orientation is a 26°/−5° holographic mirror. (FIG. 12B, orientation 2) The normal of the wedge glass surface is toward the incident beam. The resulting hologram formed from this orientation is a 6°/38° holographic mirror.

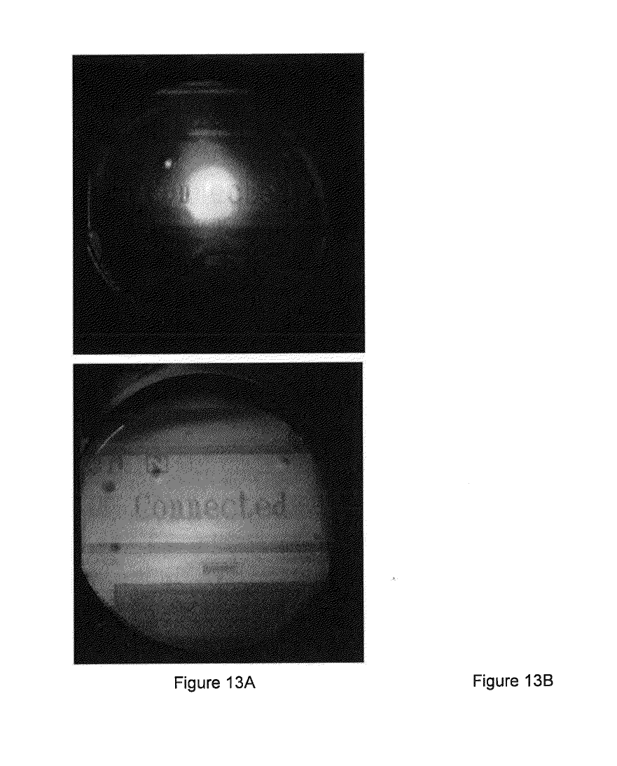

FIGS. 13A and 13B are photographs of sample D110214M using a point-like light source (tungsten halogen lamp) in FIG. 13A and using a diffuse light source (a ground-glass diffuser with same lamp) in FIG. 13B. The mirror-like appearance is apparent from FIG. 13A, although, as expected, the glare from the lamp is not coincident with the reconstructed hologram. FIG. 13B clearly demonstrates that the digital information from the display is copied well into the hologram. As expected, the hologram of the IMOD display has the similar mirror-like appearance of an IMOD display and the hologram reconstructs at an angle that is shifted relative to the glare angle. For some applications, particularly those where brightness is very important and viewing angle is less critical, this mirror-like recording is preferred. The image of the same hologram with a diffuse light source shows that the fine details of the IMOD display are recorded in this hologram.

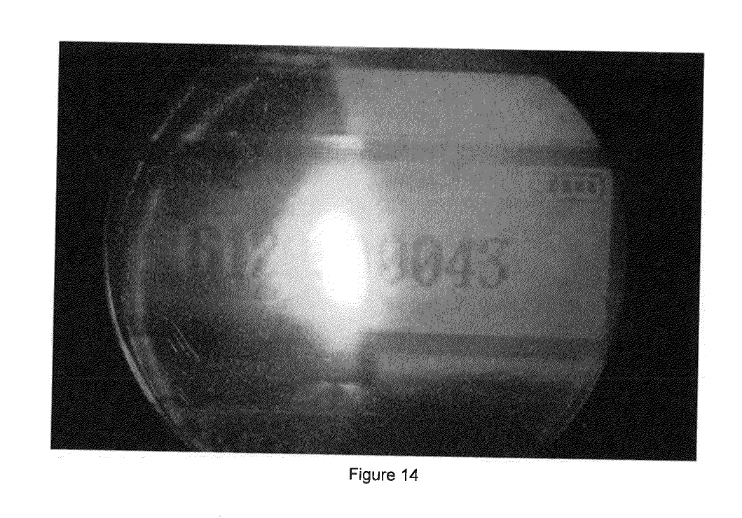

Similarly, FIG. 14 shows a photograph of another sample, D110214N. In this image both the point-like lighting and diffuse lighting are shown at the same time. Sample D110214N is illuminated using a point-like light source (tungsten halogen lamp) and a ground-glass diffuser placed in the light beam such that about half of the sample (right-side) is illuminated with light passing through the diffuser and half (left-side) is not. The left side still shows the mirror-like appearance of the hologram of the IMOD. The bright spot near the center is not glare, but the green holographic reflection of the point-like source. The right side demonstrates how the added ground-glass diffuser enables this type of hologram to be much more uniformly lit and clearly read. For some applications, the mirror-like appearance of the left can be advantageous.

As used herein, the terms “component,” “system” and the like can also refer to a computer-related entity, either hardware, a combination of hardware and software, software, or software in execution, in addition to electro-mechanical devices. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The various illustrative functional elements, logical blocks, program modules, and circuits described in connection with the aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format.

The functions of the various functional elements, logical blocks, program modules, and circuits elements described in connection with the aspects disclosed herein may be performed through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation. DSP hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The various functional elements, logical blocks, program modules, and circuits elements described in connection with the aspects disclosed herein may comprise a processing unit for executing software program instructions to provide computing and processing operations for the computer and the industrial controller. Although the processing unit may include a single processor architecture, it may be appreciated that any suitable processor architecture and/or any suitable number of processors in accordance with the described aspects. In one aspect, the processing unit may be implemented using a single integrated processor.

The functions of the various functional elements, logical blocks, program modules, and circuits elements described in connection with the aspects disclosed herein may be implemented in the general context of computer executable instructions, such as software, control modules, logic, and/or logic modules executed by the processing unit. Generally, software, control modules, logic, and/or logic modules include any software element arranged to perform particular operations. Software, control modules, logic, and/or logic modules can include routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some aspects also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, program modules, and circuits elements may be implemented in various other ways which are consistent with the described aspects. Furthermore, the operations performed by such functional elements, logical blocks, program modules, and circuits elements may be combined and/or separated for a given implementation and may be performed by a greater number or fewer number of components or program modules. As will be apparent to those of skill in the art upon reading the present disclosure, each of the individual aspects described and illustrated herein has discrete components and features which may be readily separated from or combined with the features of any of the other several aspects without departing from the scope of the present disclosure, Any recited method can be carried out in the order of events recited or in any other order which is logically possible.

It is worthy to note that any reference to “one embodiment,” “an embodiment,” “one aspect,” or “an aspect” means that a particular feature, structure, or characteristic described in connection with the aspect is included in at least one embodiment or aspect. The appearances of the phrase “in one embodiment” or “in one aspect” in the specification are not necessarily all referring to the same embodiment or aspect.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some aspects may be described using the expression “coupled” and “connected” along with their derivatives. These terms are not intended as synonyms for each other. For example, some aspects may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and aspects as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or aspects disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Although certain embodiments have been illustrated and described, many modifications, substitutions, changes and equivalents will now occur to those skilled in the art. It is therefore to be understood that the appended claims are intended to cover all such modifications and changes as fall within the scope of the disclosed aspects and appended claims.

What is claimed is:

1. A digital holographic apparatus, comprising:
an electronic display device comprising an interferometric spatial light modulator based display engine; and
a processor coupled to the electronic display device, wherein the processor is operative to upload digital content to the electronic display device,
wherein the digital content is displayed on the electronic display device and is recorded into a holographic medium when the holographic medium and the electronic display device are flood exposed by a laser generated light beam.

2. The digital holographic apparatus according to claim 1 further comprising at least one laser optically coupled to the electronic display device, wherein the at least one laser is configured to generate the light beam to flood expose the holographic medium and the electronic display device.

3. The digital holographic apparatus according to claim 2, wherein the processor is communicatively coupled to the at least one laser, wherein the processor is operative to control the at least one laser to any one of an on position to flood expose the electronic display device and an off position to stop the flood exposure.

4. The digital holographic apparatus according to claim 1 further comprising at least one optical element to couple the at least one laser generated light beam to the electronic display device.

5. The digital holographic apparatus according to claim 4, wherein the at least one optical element comprises a shutter, the system further comprising a shutter controller communicatively coupled to the shutter, wherein the shutter controller is communicatively coupled to the processor, and wherein the processor is operative to control the shutter controller.

6. The digital holographic apparatus according to claim 4, wherein the at least one optical element comprises a spatial filter interposed between the shutter and the electronic display device.

7. The digital holographic apparatus according to claim 4, wherein the at least one optical element comprises a lens interposed between the shutter and the electronic display device.

8. The digital holographic apparatus according to claim 4, wherein the at least optical element comprises a beam splitter to split the laser generated light beam into a first beam and a second beam, wherein the first beam exposes the holographic medium from a first side and the second beam exposes the holographic medium from a second side.

9. A volume hologram recorded by the digital holographic apparatus according to claim 1.

10. A method of recording a digital hologram in a holographic medium using a digital holographic system, the method comprising:
displaying digital content on a an electronic display device, the electronic display device comprising an interferometric spatial light modulator based display engine;
providing a holographic medium between a laser light source and the digital content displayed on the electronic display device; and
generating at least one laser beam by at least one laser to flood expose the holographic medium and the electronic display device to record the digital content into the holographic medium.

11. The method according to claim 10 further comprising uploading the digital content to the electronic display device by a processor.

12. The method according to claim 10 further comprising providing a diffuser element interposed between the laser light source and the electronic display device.

13. The method according to claim 10, further comprising:
transmitting the laser light through the holographic medium to a display surface of the electronic display device; and
reflecting a portion of the laser light incident upon the display surface of the electronic display device back into the holographic medium,
wherein the reflected laser light corresponds to the digital content.

14. The method according to claim 10 further comprising providing the holographic medium in direct contact with a display surface of the electronic display device.

15. The method according to claim 10 further comprising providing the holographic medium in spaced apart relation with a display surface of the electronic display device.

16. The method according to claim 10 further comprising:
splitting the at least one laser beam into a first beam and a second beam;
reflecting the first beam from the electronic display device;
exposing a first side of the holographic medium with the first beam; and
exposing a second side of the holographic medium with the second beam.

17. The method according to claim 10 further comprising:
retrieving by a processor digital content from a storage device;
uploading the digital content to the electronic display device; and
controlling the at least one laser to expose the holographic medium.

18. A volume hologram recorded by the method according to claim 10.

19. A digital holographic system, comprising:
an electronic display device comprising an interferometric spatial light modulator based display engine;
at least one laser optically coupled to the electronic display device, the at least laser operative to generate at least one light beam at first wavelength;
a processor coupled to the electronic display device and to the at least one laser,
wherein the processor is operative to upload digital content to the electronic display device, and wherein the digital content is displayed on the electronic display device and is recorded into a holographic medium when the holographic medium and the electronic display device are flood exposed by the at one laser generated light beam.

20. The digital holographic system according to claim 19, wherein the processor is communicatively coupled to the at least one laser, wherein the processor is operative to control the at least one laser to an on position to flood expose the electronic display device and to control the at least one laser to any one of an on position to flood expose the electronic display device and an off position to stop the flood exposure.

21. The system according to claim 19, comprising at least one beam splitter to split the laser generated light beam into a first beam and a second beam, wherein the first beam exposes the holographic medium from a first side and the second beam exposes the holographic medium from a second side.

22. The system according to claim 19, comprising a diffuser positioned between the at least one laser and the electronic display device.

23. A volume hologram recorded in the system according to claim 19.
